(19) United States
(12) Patent Application Publication
(10) Pub. No.: US 2024/0319429 A1
(43) Pub. Date: Sep. 26, 2024

(54) LIGHT GUIDE AND DISPLAY SCREEN USING SUCH LIGHT GUIDE

(71) Applicants: siOPTICA GmbH, Jena (DE); Nanocomp Oy Ltd, Lehmo (FI)

(72) Inventors: Joni ORAVA, Joensuu (FI); André HEBER, Weimar (DE); Markus KLIPPSTEIN, Jena (DE)

(21) Appl. No.: 18/575,828

(22) PCT Filed: Jul. 1, 2021
(86) PCT No.: PCT/EP2021/068206

§ 371 Date: Dec. 30, 2023

(51) Int. Cl. F21V 8/00

(52) U.S. Cl. CPC G02B 6/0036; G02B 6/0038; G02B 6/0091

(57) ABSTRACT

A light guide which has two main faces, each having at least one surrounding edge; the main faces connected by lateral faces at the edges. The light guide includes three-dimensionally shaped light outcoupling elements on a main face and/or within the volume enclosed by the main and lateral faces. The outcoupling elements are distributed according to a predetermined pattern. Light coupled into the light guide propagates by total internal reflection unless entering or impinging on an outcoupling element and for outcoupling, one of the two main faces is preferred over the other. The outcoupling elements are divided into groups, each group being complementary to the other groups. Group members each have a common blaze angle and a common outcoupling property, which differ from those of the members of the other groups, which results in light being outcoupled with different angular distributions, thereby reducing visible artifacts.

### PRIORITY CLAIM

The present application is a National Phase entry of PCT Application No. PCT/EP2021/068206, filed Jul. 1, 2021, the disclosure of which is hereby incorporated by reference herein in its entirety.

### FIELD OF THE INVENTION

The invention relates to a light guide which has two main faces, each main face having at least one edge surrounding it, the main faces being connected by lateral faces at the edges. The light guide comprises a plurality of three-dimensionally shaped light outcoupling elements on at least one of the main faces and/or within the volume enclosed by the main faces and the lateral faces. The light outcoupling elements are distributed according to a predetermined distribution pattern. The light guide further has a transparency of at least 70% for light passing through it by the two main faces.

### BACKGROUND OF THE INVENTION

The distribution pattern is predetermined to result, for light coupled into the light guide on at least one of the lateral faces and propagating so as to be totally internally reflected within the light guide prior to entering or impinging on an outcoupling element, in preferring one of the two main faces to couple out a higher quantity of light over the other of the two main faces. For a given material of the light guide and a range of wave lengths as well as for a given structure of outcoupling elements, predetermination of the distribution pattern is straightforward using commercially available optical design programs like LightTools' “Backlight Pattern Optimization” by Synopsys.

The outcoupling elements are provided with a longitudinal section in a plane perpendicular to at least one of the main faces. The longitudinal section is formed approximately like a polygon with at least three corners and at least three connecting lines connecting the corners. The term “approximately like a polygon” takes into account manufacturing deficiencies: While a polygon in a mathematical sense consists of a number of straight lines which are connected by an equal number of corners and form a closed polygonal circuit, the longitudinal section of an outcoupling element only resembles a polygon. Due to the manufacturing process, the shape of the connecting lines is deviating from an ideal straight line and may have slight curvatures, i. e. the connecting lines might be not straight but slightly curved lines, in particular in the corner regions where two connecting lines meet. The corners are not sharp but rounded. One of the at least three connecting lines is a selected line, which comprises least a straight segment. The orientation of the straight segment relative to the plane of the at least one main face defines a blaze angle and thereby a characteristic outcoupling property, in the way that total internal reflection is disturbed by refraction and/or reflection and a first outcoupling an gular range is defined. The blaze angle therefore determines the first outcoupling angular range as a characteristic outcoupling property. For a majority of the outcoupling elements any outcoupling element is separated from any other outcoupling element by at least one micrometer. Since outcoupling elements with literally straight lines and sharp corners are almost impossible to fabricate by lithography or any other process, at least the corners are rounded. At least in the corner regions, the straight lines therefore deviate from their ideal form and show curvatures. Depending on the size of the outcoupling elements, these curvatures can comprise up to 20% of the length of the line, if the size of the outcoupling elements is very small. These deficiencies due to the manufacturing process are understood to be tolerances included by the term “straight line”: However, even with rounded corners, in particular the line which is used to define the blaze angle comprise at least a straight segment. The blaze angle is then defined by the orientation of this straight segment relative to the plane of the at least one main surface.

Such type of outcoupling elements is known in the state of the art and often realized as recesses in an otherwise flat surface. Typical examples are shown for example in US 2018/0088270 A1, in particular FIG. 5A. However, in applications in the state of the art, light guides using such or similar outcoupling elements do not emit light in a homogeneous fashion, even if the distribution of outcoupling elements is correcting for a homogeneous luminance. Light from illumination sources usually is coupled into the light guide on the lateral faces. Near these lateral faces, hot spots—bright spots separated by smaller dark areas—are recognizable when inspecting the light guide visually; the hot spots are chained along the lateral face or edge, respectively. Further, the light guides show dispersion: Brighter and darker stripes, which in case of multicolor illumination form a rainbow-like pattern, extend on the main surface parallel to the edge of the lateral face and alternate in a direction on the main surface perpendicular to the edge. If such a light guide is used in a display, the visual impression for an observer is disturbed. However, in the state of the art no measures are disclosed to improve the visual impression by removing the hotspot and dispersion artifacts.

In EP 2 474 846 A1 a diffractive light outcoupling unit for forming a part of the directive light outcoupling system comprising a plurality of such outcoupling units is dis closed. The diffractive light outcoupling unit comprises a carrier element for accommodating a diffractive surface relief pattern and transporting light. The diffractive surface relief pattern comprises a plurality of consecutive diffractive surface relief forms defined on the predetermined surface of the carrier element. The diffractive surface relief pattern is arranged to couple light incident thereon via interaction involving at least two surface relief forms of said plurality of consecutive diffractive surface relief forms so as to enhance the directivity of the light to be outcoupled through collimation, wherein a number of light rays of the incident light to be diffracted penetrate through at least the first surface relief form during said interaction. No measures are taken to avoid the aforementioned artifacts.

EP 1 016 817 A1 discloses a light pipe for providing backlighting of a flat-panel display by means of at least one light source so that the light pipe has sponsored face which comprises certain patterns. These patterns have diffraction properties for conducting the light in the direction of the display, and the patterns comprise uniform, mutually different areas having a certain distribution on the surface of the light pipe. The local outcoupling efficiency of the light pipe depends on the characteristic properties of the patterns, which are dependent on the distance to the light source or its wavelength. The possibility of artifacts such as hot spots and rainbow-like features as mentioned before is not discussed.

U.S. Pat. No. 6,773,126 B1 describes a light panel that includes a light source and a panel element operatively connected to the light source. The panel element includes a substantially transparent light transmitting material and is operative as a waveguide panel inside which light beams received from the light source propagate with total reflection. A diffractive outcoupling system is arranged on the panel element over a light surface of the panel element and is operative to outcouple the light beams from inside the panel element. The diffractive outcoupling system includes a plurality of local grating elements. The local grating elements have a plurality of configurations and are optimized such that the diffraction efficiency is a function of location. Artifacts as mentioned before and possibilities to reduce or avoid them are not discussed.

In U.S. Pat. No. 9,261,639 B1 and optical display device is disclosed which comprises a light source, a pixelated display panel, and a light guide to collect light from the light source and to transport it via total internal reflection. A first main surface of the light guide includes recessed regions having a circular-based profile, such as quarter-circle profile, to reflect the light from the light guide to the pixelated display panel. A first optical layer covering at least a portion of the first surface of the light guide fills the recessed regions included in the first surface of the light guide. A second optical layer covering at least a portion of a second surface of the light guide transmits the reflected light to the pixelated display panel. Again, artifacts as mentioned before are not subject of a discussion.

Finally, WO 2019/087118 A1 describes a light distribution structure and related element, such as a light guide. The structure is preferably an optically functional layer comprising at least one feature pattern established in light-transmitting carrier by a plurality of three-dimensional optical features variable in terms of at least one of the parameters cross-sectional profile, dimensions, periodicity, orientation and disposition thereof within the feature pattern. The optical features are for example embodied as internal optical cavities capable to establish the total internal reflection function at a horizontal surface and at an essentially vertical surface thereof. The possibility of artifacts such as hot spots and rainbow-like features as mentioned before is not discussed here either.

In the known state of the art artifacts like hot spots and rainbow-like features related to outcoupling structures are not of interest, if observed at all, and consequently, no measures are described which could be applied to reduce or avoid such artifacts.

Of course it would be possible to couple the light guide with additional optical layers like diffusors or prism sheets. These measures, however, would increase not only the thickness of the layer assembly incorporated in a display, but also possibly reduce the brightness and/or the angular luminance distribution. Since in particular the thickness of the layer assembly becomes a more and more crucial feature in nowadays applications, to use additional layers would be a disadvantage.

### SUMMARY OF THE INVENTION

An object of the invention therefore is to improve a light guide as it has been described above, to avoid or at least to reduce artifacts like hot spots or rain-bow-like features, under the condition that no additional optical layers must be involved, in particular when using the light guide in a display screen.

This object is realized by dividing the plurality of outcoupling elements into—at least two—groups of outcoupling elements. Each group is complementary to each of the other groups, meaning that a randomly selected outcoupling element belongs only to one of the groups of outcoupling elements. The members of each group of outcoupling elements have a common characteristic blaze angle and therefore a common characteristic outcoupling property as mentioned in the beginning. The common characteristic blaze angle and the common characteristic outcoupling property differ from the characteristic outcoupling properties and blaze angles of the members of the other groups, i.e. each group of outcoupling elements has its own, unique blaze angle and, consequently, outcoupling property. This results in light being outcoupled with different angular distributions for different groups of outcoupling elements. Each group of outcoupling elements therefore is responsible for light being outcoupled with a certain angular distribution, in particular with a first angular range. These different angular distributions of light are mixed at least partially, effecting that visual artifacts—in particular rainbow—like features and hot spots—in the outcoupled light characteristics are minimized or at least diminished compared to the state of the art.

The groups comprising different outcoupling elements may have the same size, each comprising the same number of outcoupling elements, but this is not a necessary condition, and the groups can comprise different numbers of outcoupling elements. In fact, the numbers might differ by a very large amount. For improving the results, it is sufficient to define only two groups of outcoupling elements, which one of the groups comprising 99% of all outcoupling elements—i.e. the plurality of outcoupling elements—and the other group comprising only 1% of all outcoupling elements. However, the results in avoiding visual artifacts can be improved further by assigning more of the out-coupling elements to the other group. When predefining the relation between the sizes of groups in an optimization process, this is started with groups having about the same number of elements.

The outcoupling angular distribution consists at least of the first angular range, which is defined by a projection onto the plane of the longitudinal section, but preferably it consists also of a second angular range, which is defined by a projection onto the main face. Both angular ranges are specific outcoupling properties. The second angular range, however, does not depend on the blaze angle, as will be described further below. The size of the first angular range mainly depends on the angular spectrum of the incident light. All groups of outcoupling elements differ at least in the first angular range, but preferably, the groups of outcoupling elements differ in both the first and second angular range, which allows for an even better reduction of artifacts compared to differing in only either the first or the second angular range.

As mentioned in the beginning, the longitudinal section is formed approximately like a polygon with at least three corners and an equal number of connecting lines. In an advantageous embodiment, the approximate polygon has exactly three corners-which are connected by three connecting lines. Again, the term “formed approximately like a polygon” refers to the ideal form and includes tolerances due to manufacturing deficiencies. On a microscopic scale, a surface roughness between 5 nm and 10 nm is possible. A first connecting line is a base line with a straight segment lying in the plane parallel to one of the main faces. A second connecting line is arranged in an angle between 75° and 90°, preferably in an angle between 85° and 89°, in particular in an angle of 88° to the first connecting line. Finally, a third connecting line—which is the selected line—connects distant ends of the first and second connecting lines. The third connecting line defines the characteristic outcoupling property by enclosing a blaze angle with the first connecting line. Each of the first and third connecting lines and preferably also the second connecting line comprises at least a straight segment with a length of usually at least 60% of the whole length of the line, the straight segment extends to both sides of the center of the respective line. The second connecting line, however, due to manufacturing reasons might in fact be formed like an “S” curb with a very slight curvature along the most part of the line, making it difficult to define a straight segment. To define the second connecting line and in particular the angle to the first connecting line appropriately in such a case, it is approximated by a straight approximation line corresponding to the tangential line taken at the center of the second connecting line. Light guides comprising outcoupling elements with such a shape are easier to manufacture compared to those with curved connecting lines. However, the connecting lines might be approximated by an exponential function or a polynomial function of maximum fifth order in the optimization process, to take into account aforementioned deficiencies in manufacturing. In any case, deviations from straight lines due to production imperfections within predetermined tolerances are possible and included.

The three-dimensional shape of each of the outcoupling elements of each group is defined by a partial rotation of the longitudinal section in a plane perpendicular to the longitudinal section around a center axis parallel to that outside of the longitudinal section, with an angle of partial rotation different from 0°, preferably between 5° and 25°. The center axis in particular is parallel to the second connecting line, in case the longitudinal section has the shape of a right-angled triangle.

The angle of partial rotation basically defines the size of the second angular range, and the blaze angle basically determines the first angular range which further depends on the angles of the light incident on the surface defined by the third connecting line. In particular, the blaze angle is different for different groups of outcoupling elements. For example, while in a first group the blaze angle is 53°, it might be 57° in a second group. Both groups might contain about the same number of outcoupling elements. In another example, a first group comprises outcoupling elements with a standard blaze angle of 55°, which is in particular useful for an optimized angular distribution in light guides used in the automotive sector. Further groups contain outcoupling elements with blaze angles preferably distributed symmetrically around the standard blaze angle of 55°, for example 54° and 56° in a second and third group, respectively, or 53° and 57°. Even more groups of outcoupling elements can be defined, for example in total five groups with deviations of −3°, −2°, 0°, 2° and 3° around a standard blaze angle, which might not necessarily be 55°. Each of the groups may contain about 20% of all outcoupling elements.

It is also possible to provide outcoupling elements in at least one group of the outcoupling elements for which the blaze angle varies continuously or discretely between two end positions of the partial rotation at least for the outcoupling elements of one of the groups of outcoupling elements. This particular embodiment is-apart from the fact that it helps to improve reducing the artifacts even more-useful from a manufacturer's point of view: By using outcoupling elements with a varying blaze angle, it is possible to use only one group of outcoupling elements, which is easier to produce. This is a special case of the invention in which only two groups of outcoupling elements are realized, but the second group has no members, since it is an empty group. Effectively, there is then only one group. Nevertheless, this particular embodiment also reduces artifacts efficiently when applied to one group or more groups of outcoupling elements.

The light guide typically consists of a transparent, thermoplastic or thermos-elastic plastic material or of glass. The outcoupling elements usually have a maximum size of 100 μm in each spatial direction, preferably between 1 μm and 30 μm. In this way, it can be avoided that the outcoupling elements themselves become visible to an observer when the light guide is in use. Further, if the size of each outcoupling element is smaller than a subpixel of an LC panel, several outcoupling elements can cover a subpixel, which helps to reduce or even avoid so-called color sparkling.

The outcoupling elements of at least one group of outcoupling elements are either protruding out of or extending into at least one of the main faces. Alternatively or in combination the outcoupling elements can also be shaped as microprisms. Further, the outcoupling elements of at least one group of outcoupling elements can be formed as cavities inside the light guide. In this case, the cavities are either evacuated or filled with a material which has a refractive index and/or a haze value different from the refractive index or haze value, respectively, of a material of the light guide. In case of the refractive index, the refractive index inside the cavity is preferably lower than in the light guide outside of the cavity, and in case of the haze value, the haze value inside the cavity is preferably higher than in the light guide outside of the cavity. It is of course possible to realize each group of outcoupling elements differently. For example, a first group of out coupling elements might be extending into one of the main faces, while a second group might be shaped as microprisms protruding out of one of the main faces, and a third group comprises outcoupling elements which are formed as cavities. If the light guide is an element within a stack of other optical layers, it is of course advantageous to keep the height of the light guide in the stack as small as possible and to prefer outcoupling elements extending into the main face, which are also easier to manufacture compared to cavities within the light guide, since they can be applied after the light guide has been fabricated.

The distribution pattern of the outcoupling elements on the at least one main face and/or within the volume of the light guide preferably is predetermined to couple out light by the outcoupling elements with a luminance uniformity of at least 60% in luminance, preferably 70% or more, on at least one of the two main faces. With such a white uniformity, artifacts are not disturbingly visible anymore for a user of a device equipped with such a light guide. The distribution pattern can be predetermined by commercially available optical simulation programs like “Blacklight Pattern Optimization” modules from LightTools by Syopsis which may include such a condition as input for the optimization process. The luminance uniformity is being measured by a nine-point procedure, using a camera positioned vertically above the main face in a distance of 90 cm. For reference see Information Display Measurement Standard Chapter 8, issued by the International Committee for Display Metrology, Version 1.03 of Jun. 1, 2021.

The distribution patterns can for example be chosen so that close to the lateral face where light is coupled into the light guide—in case that two groups of outcoupling elements are used—elements of both groups are equally provided in a relation of about 50% to 50%, while with increasing distance from said lateral face elements of one of the groups dominate over the other, continuously growing to a relation of 100% to 0%. This will increase overall luminance for predetermined viewing angle areas of displays incorporating such light guides. By choosing the distribution patterns in this way, it is also possible to take into account that the angular spectrum of the light coupled into the light guide might vary between the lateral face where light is coupled in and the lateral face opposite to it.

Further, each of the outcoupling elements contributes more or less to an overall haze of the light guide. In a preferred embodiment, (i) the distribution pattern of the outcoupling elements on the at least one main face and/or within the volume of the light guide, (ii) the number of outcoupling elements, and (iii) their size is predetermined to yield an average haze of 30% or less on at least 50% on one of the main faces. Here, the haze value is measured according to ASTM D 1003-13, Procedure A.

The invention also relates to a display screen comprising a light guide as described above. In addition to the light guide, the display screen comprises one or more light sources emitting light to be coupled into the light guide at least at one of the lateral faces. It further comprises a transmissive display panel located in front of the light guide as seen from an observer. The transmissive display panel and the light guide are separated typically only by an air layer or optically bonded to each other, in most cases no further optical layer is arranged between the display panel and the light guide.

The light guide comprises outcoupling elements, and usually, the transmissive display panel comprises pixels. In such a case, the spatial extension of the outcoupling elements is smaller than the spatial extension of a pixel for each of the dimensions in a Cartesian space, to increase uniformity even more, with reduced or even without contrast or color sparkling. In case the transmissive display panel comprises pixels which consist of subpixels, the spatial extension of the outcoupling elements preferably is smaller than the spatial extension of us a pixel for each of the dimensions in a Cartesian space.

It should be understood that the previously mentioned features and the features to be explained in the following are applicable not only in the combinations described, but also in different combinations or alone, without leaving the framework of the invention described herein.

### BRIEF DESCRIPTION OF THE DRAWINGS

Below, the invention will be explained in more detail with reference to the accompanying drawings, which also show features essential to the invention, among other features. The embodiments shown in the drawings serve to illustrate the invention and are not to be considered limiting the invention to the drawings. For example, the description of an embodiment with a plurality of elements or components is not to be interpreted in the sense that all of these elements or components must be present to implement the invention. In fact, different embodiments may comprise alternative elements or components, less elements or components, or additional elements or components. Elements or components of different embodiments may be combined with each other, unless the contrary is explicitly mentioned. Modifications and variations, which are described for one of the embodiments, might be applicable to other embodiments as well. To avoid recurrences, the same elements or elements in different figures, which are correlated with each other, are assigned the same reference numerals and not repeatedly explained. In the drawings show

FIG. 1 a light guide in a bottom view,

FIG. 2 a section through a light guide,

FIG. 3A)-C) an outcoupling element with idealized shape,

FIG. 4A)-C) an outcoupling element as manufactured by lithography,

FIG. 5A), B) two outcoupling elements with different first angular ranges,

FIG. 6A), B) the outcoupling elements of FIG. 6 with different second angular ranges, and

FIG. 7 a display with a light guide.

### DETAILED DESCRIPTION OF THE DRAWINGS

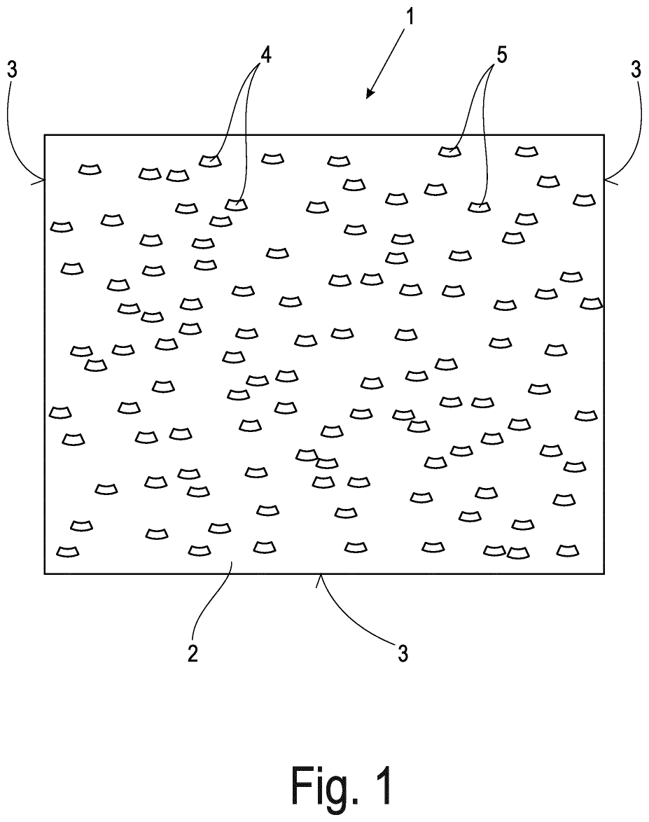

FIG. 1 shows a light guide 1 which has two main faces, a bottom main face and a top main face. Shown here is the bottom main face 2, however, in other configurations this could be as well the top main face. Each main face has at least one edge surrounding it. In the example of FIG. 1, the bottom main face 2 as well as the top main face have four edges 3 surrounding them. The shape of the edges 3 surrounding the light guide 1 depend mainly on the purpose where light guide 1 is used. In ATMs or laptops for example, the shape mostly will look like similar to what is shown in FIG. 1. However, in cars the shape has to follow more or less the design, with round edges or differently shaped edges. The light guide 1 in the example shown is plate-shaped, the two main faces are planar and parallel to each other. In other embodiments, the main faces may have curvatures and/or may form a wedge. At the edges 3, the main faces are connected by lateral faces, which in the example shown in FIG. 1 are arranged perpendicular to the paper plane. The light guide 1 has a transparency of at least 70% for light passing through it by the two main faces.

The light guide 1 comprises a plurality of three-dimensionally shaped light out-coupling elements 4, 5 on at least one of the main faces. In the example of FIG. 1, the light outcoupling elements 4, 5 are located on the bottom main face 2 only. Other embodiments of a light guide comprise light outcoupling elements 4, 5 additionally or alternatively on the top main face. Additionally or alternatively it is also possible to provide the plurality of light outcoupling elements 4, 5 within a volume enclosed by the main faces and the lateral faces. For a majority of outcoupling elements 4, 5, any outcoupling element 4, 5 is separated from any other outcoupling element 4, 5 by at least one micrometer. The outcoupling elements 4, 5 are provided with a longitudinal section in a plane perpendicular to the bottom main face 2. The longitudinal section is formed approximately like a polygon with three corners and three connecting lines connecting the corners. One of the three connecting lines is a selected line which comprises at least a straight segment if it is not straight over the whole length. As will be explained further below, the orientation of the straight segment relative to the bottom main face 2 defines a blaze angle and thereby a characteristic outcoupling property, in a way that total internal reflection is disturbed by refraction and/or reflection and a first outcoupling angular range is defined.

The plurality of outcoupling elements 4, 5 is divided into groups of outcoupling elements 4, 5. Each group is complementary to each of the other groups and the members of each group have a common characteristic blaze angle and therefore at least one common characteristic outcoupling property, which differ from the characteristic outcoupling properties and blaze angles of the members of the other groups. As a consequence, light is outcoupled with different angular distributions, depending on the group the respective outcoupling element belongs to. In the embodiment of FIG. 1, two groups of outcoupling elements are present, a first group with first outcoupling elements 4 and a second group with second outcoupling elements 5. However, it is also possible to have more than two groups of outcoupling elements realized in the light guide 1.

The light outcoupling elements 4, 5—or in short outcoupling elements 4, 5—are distributed according to a distribution pattern which is predetermined—e.g. by commercially available optical design programs as mentioned above—to result, for light coupled into the light guide 1 on at least one of the lateral faces and propagating so as to be totally internally reflected within the light guide 1 prior to entering or impinging on an outcoupling element 4, 5, in preferring one of the two main faces to couple out a higher quantity of light over the other of the two main faces. For total internal reflection, light has to be coupled into the light guide only in a limited angular range.

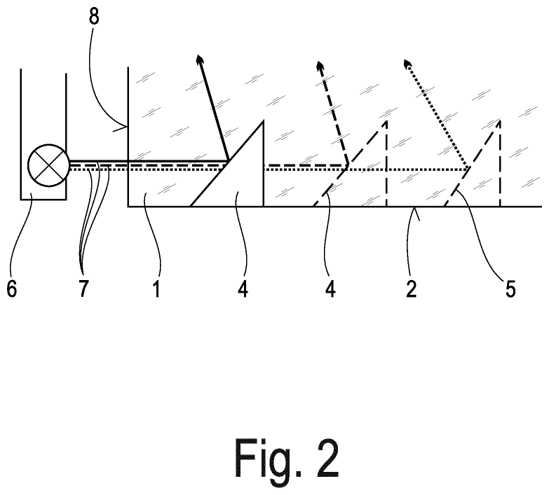

In the embodiment shown in FIG. 1, where light outcoupling elements 4, 5 are located at the bottom main face 2, the top main face is preferred to couple out a higher quantity of light over the bottom main face 2. This is shown in more detail in FIG. 2 which shows a section through a light guide 1 similar to that of FIG. 1. However, the outcoupling elements 4 and 5 just for the purpose of better understanding in FIG. 2 are arranged equidistant to each other, which in reality is not the case. Related to FIG. 1, such a section would be perpendicular to the paper plane and from bottom to top, corresponding from left to right in FIG. 2. On the left side of FIG. 2, a light source 6 is arranged which emits light along light beams 7 which enter the light guide 1 through a lateral face 8. With respect to FIG. 1, this lateral face 8 would be located at the lower edge 3 of the bottom main face 2. It should be noted that the light source 6 does not emit a single beam, but it emits light along a major part of the lateral face. This is symbolized in FIG. 2 by several light beams 7, a solid one, a dashed one, and a dot-dashed one, corresponding to different depths perpendicular to the paper plane. It further should be noted that the light beams 7 are emitted within a small angular range which allows the light to propagate through the light guide 1 without being coupled out in the absence of outcoupling elements 4, 5, since the angular spectrum is limited to angles allowing the light to be totally internally reflected at the planar main faces. The lateral face opposite to the light source 6 usually may be provided with a reflective coating to minimize the loss of light.

However, due to the presence of first and second outcoupling elements 4, 5 light will be coupled out of the light guide 1. The solid light beam 7 enters the light guide 1 at the lateral face 8. It is totally internally reflected on the leftmost outcoupling element 4, drawn with a solid line as well. The light is reflected with such an angle that it will pass through the top main face of the light guide 1 and can leave it at a specified angle. The same holds for the dashed light beam 7, which is reflected at another first outcoupling element 4 which is located deeper in the light guide 1, as seen from the paper plane. Finally, a light beam 7 shown as a dot-dashed line is reflected at a second outcoupling element 5 which is located between the other two light outcoupling elements 4 in the light guide 1, regarding the depth dimension of the light guide 1. However, the second out coupling element 5 has a shape which differs slightly from the shape of the first outcoupling element 4. Therefore, the angle of reflection is different and the dot-dashed light beam 7 leaves the light guide at a different angle, compared to the light reflected at the first outcoupling elements 4. Together with the predetermined distribution of the outcoupling elements, this helps to reduce artifacts like hot spots or rainbow-like features.

The light outcoupling elements 4, 5 usually have a maximum size of 100 μm in each spatial direction, but preferably their maximum size is between 1 μm and 30 μm. While they are formed as recesses and therefore are extending into the bottom main face 2 in the embodiment shown in FIGS. 1 and 2, it is also possible that the outcoupling elements are formed on both main faces or as cavities inside the light guide. They can also be formed as protrusions and/or be shaped as microprisms. In case the outcoupling elements are formed as cavities, these are either evacuated or filled with a material which has a refractive index and/or a haze value different from the refractive index or haze value, respectively, of a material of the light guide 1. The light guide 1 can be made of a thermoplastic material, for example PMMA, Polycarbonate, PMMI or also of glass. It is also possible that the at least two groups of outcoupling elements comprise different types of outcoupling elements. For example, a first group of outcoupling elements could comprise outcoupling elements which are formed as protrusions from at least one of the main faces, while outcoupling elements of a second group are formed as cavities inside the light guide 1 and outcoupling elements of a third group are formed as recesses on at least one of the two main faces.

The distribution pattern of the outcoupling elements 4, 5 on at least one of the two main faces and/or within the volume of the light guide 1, in the embodiment shown in FIG. 1 on the bottom main face 2, preferably is predetermined to couple out light by the outcoupling elements 4, 5 with a luminance uniformity of at least 60% on at least one of the two main faces, here the top main face.

Preferably, each of the outcoupling elements 4, 5 contributes to an overall haze of the light guide 1, and the distribution pattern of the outcoupling elements 4, 5 on the bottom main face 2, the number of outcoupling elements 4, 5 and their size is predetermined to yield an average haze of 30% or less on at least 50% on the top main face, i. e. on the face opposite to the one where the outcoupling elements 4, 5 are located. In this way, each of the outcoupling elements contributes to an overall haze of the light guide 1. The haze can be measured for example according to ASTM D 1003-13.

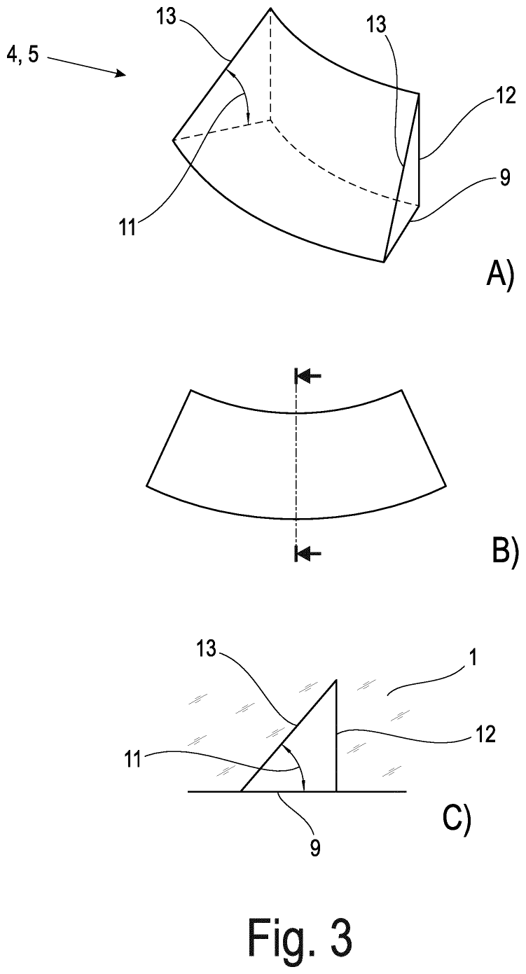

In the following, the outcoupling elements 4 and 5 will described in more detail. FIG. 3 shows an outcoupling element 4 or 5 with idealized shape. FIG. 3A) shows a perspective view of an outcoupling element, FIG. 3B) shows a projected view from top or bottom and FIG. 3C) shows a longitudinal section of the coupling element 4, 5 along the dot-dashed line marked in FIG. 3B).

A longitudinal section always means a section through an outcoupling element along a plane as shown in FIG. 3B), i. e. along a direction congruent with the shortest distance between an entry point and an exit point along the dot-dashed line in FIG. 3B), so that the area of the section is minimal. Since the curved lines of the projected outcoupling element in FIG. 3B) have the shape of an arc with a common center point, the section plane cuts both arcs perpendicular to their tangents.

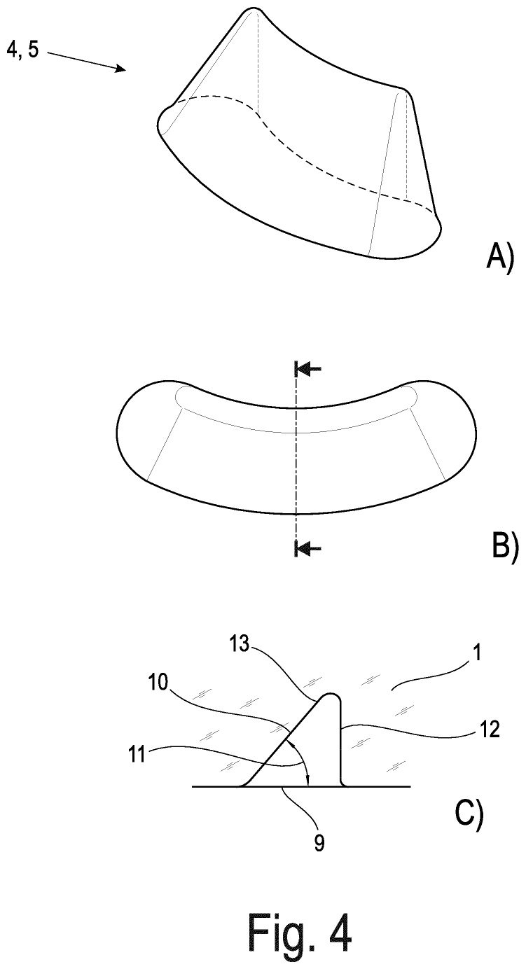

However, due to limitations in the manufacturing process, for example by using photolithographic techniques to create optical tools but also by using nanoimprint and/or injection molding processes to produce light guides, it is rather difficult to fabricate ideal structures as shown in FIG. 3A)-3C). The real structure of the outcoupling elements 4, 5 therefore deviates more or less from this ideal shape and looks more like the one displayed in FIG. 4A)-4C). In particular, the corners are rounded, as can be seen in the longitudinal section shown in FIG. 4C).

In general, each outcoupling element 4, 5 is provided with a longitudinal section as shown for example in FIG. 3C) or FIG. 4C) in a plane perpendicular to at least one of the main faces, with the longitudinal section being formed approximately like a polygon with at least three corners and at least three connecting lines connecting the corners, the connecting lines being curved or straight. The longitudinal section in FIG. 3C) has three corners which are connected by straight lines. The more realistic longitudinal section shown in FIG. 4C) on the other hand has rounded corners. The underlying polygon can be defined in two ways which are equivalent with respect to the optical effect, since this effect—as will be described further below-does not depend on the real shape of the corners. A first possibility is to extend the straight lines or segments of straight lines further until they cross each other, resulting in a shape like the one displayed in FIG. 3C). A second possibility is to approximate the rounded corners by a large number of short, straight lines. In the limit of infinitesimally short lines, the rounded corners can be approximated by a function, e. g. by a polynomial function. In the longitudinal section displayed in FIG. 4C), the outcoupling element 4, 5 is formed as a recess in the light guide 1, with the plane of the bottom main face 2 being perpendicular to the paper plane and containing a—with respect to the paper plane—horizontal base line 9 of the outcoupling element 4, 5. An outcoupling element protruding from a main face would have the same shape. In case of an outcoupling element in the volume of the light guide 1, the two lower corners, which in FIG. 4C) have a convex shape as seen from within the outcoupling element, would have a concave shape instead.

The outcoupling elements 4, 5 in FIGS. 3 and 4 have a longitudinal section which is formed like a polygon with three corners, in FIG. 4 only approximately. The corners are connected by connecting lines. A first connecting line is the base line 9 lying in a plane parallel to one of the main faces, here to the bottom main face 2. In this case, where the outcoupling elements are formed as recesses, the first connecting line is a straight line, in other embodiments it comprises at least a straight segment.

A second connecting line 12 is arranged in an angle between 75° and 90° to the base line 9. In the examples shown in FIGS. 3 and 4, the angle is 90°. However, practice has shown that it is preferable to choose an angle of less than 90°, in particular in the range between 85° and 89º, for example 88°. In any case the angle should be chosen such that light cannot impinge on the surface defined by rotation of the second connecting line 12. The second connecting line might in reality show slight curvatures and have the form of an “S”, with deviations from a straight form in a range of 5 to 10 nm, which can be considered as surface roughness. The angle is then determined as explained above.

A third connecting line 13 connects the distant ends of the base line 9 and the second connecting line 12. The third connecting line 13 is the selected line and defines a characteristic outcoupling property by enclosing the blaze angle 11 with the base line 9. If the third connecting line 13 is curved, the straight segment 10 it comprises has a length of preferably at least 60% of the full length of the third connecting line 13. A length of less than 60% will work too, however, the efficiency will drop somewhat. In case of the outcoupling elements 4, 5 as shown in FIG. 1 and FIG. 2, which are formed as recesses in the light guide 1, outcoupling is effected by reflection at the straight line 13 or the straight segment 10, respectively, after which the light can leave the light guide 1 through the main face on the opposite side.

The orientation of the straight segment 10 or the straight line relative to the plane of the at least one main face—here the bottom main face 2—defines a blaze angle 11 and thereby a characteristic outcoupling property in a way that total internal reflection is disturbed by reflection and/or refraction for light impinging on the respective surface comprising the straight segment 10 and a first outcoupling angular range is defined as a characteristic outcoupling property. In other words, the outcoupling angular range is directly related to and depends on the orientation of the straight line or the straight segment 10, respectively, relative to the plane of the main face.

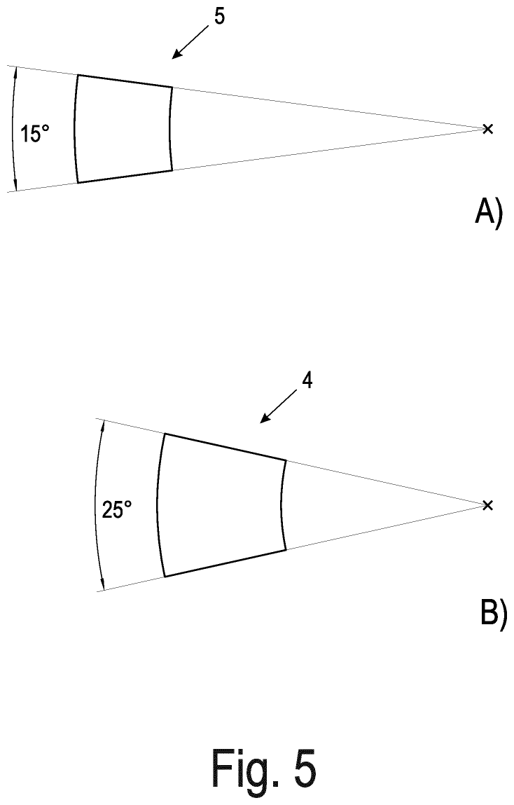

The three-dimensional shape of each of the outcoupling elements 4, 5 in this embodiment is defined by a partial rotation of the longitudinal section in a plane perpendicular to the longitudinal section around a center axis parallel to but outside of the longitudinal section. Another possibility is to define the three-dimensional shape by a translation of the longitudinal section. The rotation of the third connecting line 13 defines the plane at which the light beams 7 of FIG. 2 are reflected or, in other embodiments, refracted. The angle of partial rotation is different from 0° and preferably in a range between 5° and 25°, including these angles. This can be seen in FIGS. 3A) and 4A), showing a perspective view of an outcoupling element 4, 5, and FIG. 5 showing two examples for outcoupling elements with different partial angles. FIG. 5A) shows a bottom view onto a first outcoupling element 4, i. e. along a viewing direction from the bottom main face 2 into the inside of light guide 1. FIG. 5B) shows a bottom view onto the second outcoupling element 5. The center axis is marked by cross and is orientated perpendicular to the paper plane. The angle of partial rotation for the first outcoupling element 4 is 25° and larger than for the second outcoupling element 5, for which the angle of partial rotation is 15°. Furthermore, the arc of the reflecting surface of the second outcoupling element 5 has a stronger curvature than that of the first outcoupling element 4, since the radius, i. e. the distance to the center axis is shorter for the second outcoupling element 5.

In the examples shown in FIG. 3 and FIG. 4, the longitudinal section has always the same shape, independent of where the section is taken. The blaze angle 11 therefore is constant all over the respective outcoupling element. However, it is also possible to combine the partial rotation with a discrete or continuous change in the blaze angle 11 as a function of the rotational angle, meaning that the shape of the longitudinal section is dependent on the position with respect to the rotation. The blaze angle 11 can vary either continuously or discretely between two end positions of the partial rotation, for example between 53° and 57°. In an advantageous embodiment, the blaze angle varies for at least one group of outcoupling elements. This helps to reduce artifacts even further and basically allows to use only one group of outcoupling elements, which is easier to fabricate.

As mentioned previously, the light guide comprises a plurality of outcoupling elements which is divided into at least two complementary groups of outcoupling elements. In the embodiment related to the drawings, the plurality of outcoupling elements is divided into two groups, the members of each group having a common characteristic blaze angle 11 and therefore a common characteristic outcoupling property, which differ from the characteristic outcoupling properties and blaze angle of the members of the other group. This results in light being outcoupled with different angular distributions for different groups of outcoupling elements. In the embodiment discussed above, the outcoupling angular distribution comprises a first and a second angular range. The latter one is defined by a projection onto a main face. This is shown in FIG. 5A) for the first outcoupling element 4 and in FIG. 5B) for the second outcoupling element 5. The second angular range is defined by the angle of partial rotation, corresponding to the size of the respective segment with respect to a full rotation of 360° resulting in a doughnut shape. The angle of partial rotation is directly connected to the second angular range and defines a second characteristic outcoupling property which is not related to the blaze angle 11. While the blaze angle 11 must be different for different groups of outcoupling elements 4, 5, the angle of partial rotation and therefore the second characteristic outcoupling property might be the same for all groups.

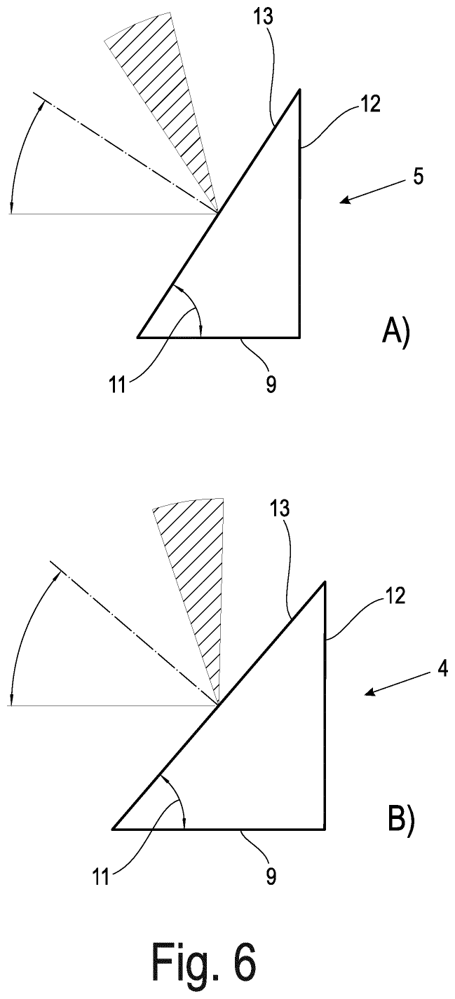

The outcoupling angular distribution comprises further the first angular range which is defined by a projection onto the plane of the longitudinal section. This is shown in FIG. 6A) for the first outcoupling element 4 and in FIG. 6B) for the second outcoupling element 5. As described in relation to FIG. 2, light enters the light guide 1 with different angles within a limited angular spectrum. Light beams within this angular spectrum are eventually reflected on the plane defined by rotation of the third connecting line 13 as described in relation to FIG. 3 and FIG. 4. The respective first angular ranges are shown as shaded cones and are different when measured with respect to the base line 9. Light impinging on the surface as defined by rotation of the third connecting line 13 along the—with respect to the paper plane—horizontal direction is reflected in a direction bisecting the shaded cone. The first angular range is directly related to the blaze angle 11, which defines the inclination of the third connecting line 13—or its straight segment 10—and therefore of the plane in which the light beams are reflected, as can be seen from FIG. 6A) and FIG. 6B). The first angular range defines a first characteristic outcoupling property which is the same for members of the same group of outcoupling elements, but different for members of different groups of outcoupling elements.

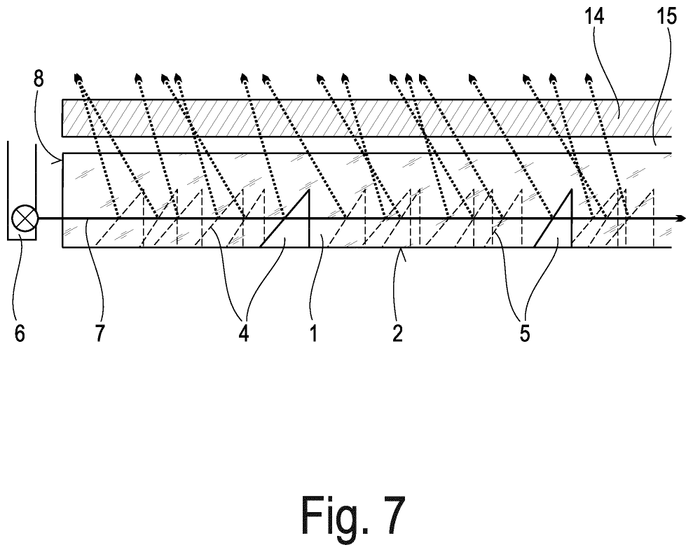

FIG. 7 shows a display screen which comprises a light guide 1 as described above. It further comprises one or more light sources 6 emitting light to be coupled into the light guide 1 at least at one of the lateral faces 8, here at the lateral face 8 on the left side. In front of the light guide 1—as seen from an observer—a transmissive display panel 14 is located. In the embodiment shown in FIG. 7, the transmissive display panel 14 and the light guide 1 are separated only by an air layer 15 and there are no other optical components arranged between the transmissive display panel 14 and the light guide 1. Alternatively, it is also possible to optically bond the transmissive display panel 14 to the light guide 1 by a highly transparent adhesive having a refractive index adapted to the refractive index of the light guide 1 to minimize reflections, whereby the refractive index of the bonding material has to be lower than the refractive index of the material of which the light guide 1 consists, in order to allow total internal reflection within the light guide 1. Avoiding the use of additional optical layers minimizes a potential loss in bright ness of the display, which is important in bright environments.

When the light guide 1 is used with a transmissive display panel 14 comprising pixels or pixels which themselves consist of subpixels, the spatial extension of the out-coupling elements 4, 5 is preferably smaller than the spatial extension of a pixel or sub pixel, respectively, for each of the dimensions in a Cartesian space, i.e. in each of the three spatial directions.

The light guide 1 described above when used with the transmissive display panel 14 enhances viewing experience for an observer, since artifacts like hot spots or rain-bow-like features are massively reduced compared to transmissive display panels with light guides as known in the state of the art.

### LIST OF REFERENCE NUMERALS

1 light guide
2 bottom main face
3 edge
4 first outcoupling element
5 second outcoupling element
6 light source
7 light beam
8 lateral face
9 base line
10 straight segment
11 blaze angle
12 second connecting line
13 third connecting line
14 transmissive display panel

1. A light guide, comprising:
two main faces, each main face having at least one edge surrounding it, the main faces being connected by lateral faces at the edges; and
a plurality of three-dimensionally shaped light outcoupling elements on at least one of the main faces and/or within a volume enclosed by the main faces and the lateral faces, the light outcoupling elements being distributed according to a predetermined distribution pattern;
wherein:
the light guide has a transparency of at least 70% for light passing through the light guide by the two main faces;
the distribution pattern is predetermined to result, for light coupled into the light guide on at least one of the lateral faces and propagating so as to be totally internally reflected within the light guide prior to entering or impinging on an outcoupling element, in preferring one of the two main faces to couple out a higher quantity of light over the other of the two main faces;
the outcoupling elements are provided with a longitudinal section in a plane perpendicular to at least one of the main faces, the longitudinal section being formed approximately like a polygon with at least three corners and at least three connecting lines connecting the corners, with one of the at least three connecting lines being a selected line, which comprises at least a straight segment;
an orientation of the straight segment relative to the plane of the at least one main face defines a blaze angle and thereby a characteristic outcoupling property, in a way that total internal reflection is disturbed by refraction and/or reflection and a first outcoupling angular range is defined;
whereas for a majority of the outcoupling elements any outcoupling element is separated from any other by at least one micrometer; and
the plurality of outcoupling elements is divided into groups of outcoupling elements, each group being complementary to each of the other groups and members of each group having a common characteristic blaze angle and therefore a common characteristic outcoupling property, with the common characteristic blaze angle and the common characteristic property differing from the characteristic blaze angles and outcoupling properties of members of the other groups, thereby resulting in light being outcoupled with different angular distributions for different groups of outcoupling elements.

2. The light guide according to claim 1, wherein the outcoupling angular distribution consists of the first angular range defined by a projection onto the plane of the longitudinal section and a second angular range defined by a projection onto the main face.

3. The light guide according to claim 1, wherein the longitudinal section is formed like a polygon with three corners which are connected by three connecting lines, a first connecting line being a base line with a straight segment lying in a plane parallel to one of the main faces, a second connecting line arranged in an angle between 85° and 90° to the first connecting line, and a third connecting line connecting distant ends of the first and second connecting line, with the third connecting line being the selected line and defining a characteristic outcoupling property by enclosing a blaze angle with the first connecting line.

4. The light guide according to claim 3, wherein the three-dimensional shape of each of the outcoupling elements is defined by a partial rotation of the longitudinal section in a plane perpendicular to the longitudinal section around a center axis parallel to but outside of the longitudinal section, with an angle of partial rotation different from 0°.

5. The light guide according to claim 4, wherein for at least one group of outcoupling elements, the blaze angle varies continuously or discretely between two end positions of the partial rotation at least for the outcoupling elements of one of the groups of outcoupling elements.

6. The light guide according to claim 1, wherein the outcoupling elements have a maximum size of 100 μm in each spatial direction.

7. The light guide according to claim 1, wherein the distribution pattern of the outcoupling elements on the at least one main face and/or within the volume of the light guide is predetermined to couple out light by the outcoupling elements with a luminance uniformity of at least 60% on at least one of the two main faces, the luminance uniformity being measured by a nine-point procedure.

8. The light guide according to claim 1, wherein each of the outcoupling elements contributes to an overall haze of the light guide and that the distribution pattern of the outcoupling elements on the at least one main face and/or within the volume of the light guide, the number of outcoupling elements and their size is predetermined to yield an average haze of 30% or less on at least 50% on one of the main faces, the haze being measured according to ASTM D1003-13.

9. The light guide according to claim 1, wherein the outcoupling elements of at least one group of outcoupling elements are protruding out of or extending into at least one of the main faces and/or are shaped as microprisms.

10. The light guide according to claim 1, wherein the outcoupling elements of at least one group of outcoupling elements or are formed as cavities inside the light guide, the cavities being either evacuated or filled with a material which has a refractive index and/or a haze value different from the refractive index or haze value, respectively, of a material of the light guide.

11. A display screen, comprising:
a light guide according to claim 1,
one or more light sources emitting light to be coupled into the light guide at least at one of the lateral faces, and
a transmissive display panel located in front of the light guide as seen from an observer.

12. The display screen according to claim 11, with the transmissive display panel comprising pixels, and the light guide comprising outcoupling elements, wherein a spatial extension of the outcoupling elements is smaller than a spatial extension of a pixel for each of the dimensions in a Cartesian space.

13. The display screen according to claim 12, with the transmissive display panel comprising pixels which consist of subpixels, and the light guide comprising outcoupling elements, wherein the spatial extension of the outcoupling elements is smaller than a spatial extension of a subpixel for each of the dimensions in a Cartesian space.

14. The display screen according to claim 11, with the transmissive display panel and the light guide being separated only by an air layer or being optically bonded.

15. The light guide according to claim 3, wherein the three-dimensional shape of each of the outcoupling elements is defined by a partial rotation of the longitudinal section in a plane perpendicular to the longitudinal section around a center axis parallel to but outside of the longitudinal section, with an angle of partial rotation different between 5° and 25°.

16. The light guide according to claim 15, wherein for at least one group of outcoupling elements, the blaze angle varies continuously or discretely between two end positions of the partial rotation at least for the outcoupling elements of one of the groups of outcoupling elements.

17. The light guide according to claim 1, wherein the outcoupling elements have a maximum size of between 1 μm and 30 μm in each spatial direction.
